(19) United States
(12) Patent Application Publication
(10) Pub. No.: US 2002/0032665 A1
(43) Pub. Date: Mar. 14, 2002

(54) Methods and systems for authenticating business partners for secured electronic transactions

(76) Inventors: Neal Creighton, Alpharetta, GA (US); Christopher T.M. Bailey, Atlanta, GA (US); Daniel P. Corcoran, San Jose, CA (US); Kefeng Chen, Duluth, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/906,857

(22) Filed: Jul. 17, 2001

Related U.S. Application Data
(60) Provisional application No. 60/218,527, filed on Jul. 17, 2000.

(51) Int. Cl. G06F 17/60

(52) U.S. Cl. 705/76; 705/64; 705/75

(57) ABSTRACT

The present invention relates generally to methods and systems that enable organizations to make secure a wide array of electronic transactions such as business-to-business transactions over corporate extranets. One aspect of the present invention, allows companies to work through an extranet with existing and new business partners. The new business partners are directed to obtain certification from a certification authority, which takes corporate information from the business partners and verifies them. If the corporate information is verified against third party sources, a digital certificate is automatically issued.

### CROSS-REFERENCE TO RELATED APPLICATION

This application claims priority to U.S. Provisional Application No. 60/218,527, entitled “System and Method for Secure Electronic Transactions with Extensible Interface” filed on Jul. 17, 2000.

### FIELD OF THE INVENTION

The present invention relates generally to distribute computing systems. Particularly, it relates to a system and method for authenticating a remote user. More particularly, it relates to a method and system for issuing digital certificates to remote users as online credentials to access an extranet.

### BACKGROUND OF THE INVENTION

One of the obstacles for companies doing business with other companies over the Internet is the difficulty for one party to ascertain the identity of another party. Customarily, a business owner authenticates each potential business partner before granting access to sensitive information to the potential business partner. The business owner is generally capable of taking information from a potential business partner and then performing research to confirm the veracity of the information. The information provided by the potential business partner may include Article of Incorporation, Tax Identification Number, business license, state license, etc. When dealing with an individual representing a corporation, the business owner may also request a letter of authorization from the president of the corporation. The information collected is checked against independent sources, such as the Secretary of State of state of incorporation, Internal Revenue Services (IRS), corporation's own record, commercial business directory services, credit reporting agencies, etc. After confirming the information, the business owner grants access to the potential business partner.

The access may have different levels of permission. The business owner may grant different levels of access to different business partners. A business partner with greater assets may obtain a greater level of access, if the business owner's concern is a business partner's ability to pay damages. The business owner may also grant a greater level of access to a business partner with a high volume of sales.

The authentication process becomes more laborious and more difficult as the number of potential business partners and the level of permission increase. A business owner may be forced to maintain a dedicated staff to handle the authentication of potential business partners.

The above problem can be illustrated in case of an electronic equipment manufacturer, who is ready to launch a new product in the market. The equipment manufacturer may wish to have commercial software developers to develop a variety of software for its new product. In order to develop software that is 100% compatible with the new product, the electronic equipment manufacturer needs to make its software for the new product available to commercial software developers. The sharing of software in this scenario is easily accomplished through the Internet. The equipment manufacturer can place its software on a file server connected to the Internet, and the commercial software developers would then access the file server through the Internet to gain access to the equipment manufacturer's proprietary software. The challenge for the equipment manufacturer is to limit access to its proprietary software only to legitimate commercial software developers and not to allow access by unknown entities.

When there are a few authorized parties, the equipment manufacturer can authenticate and authorize each one of the parties. However, when the number of authorized parties becomes large, the equipment manufacturer maybe forced to have a staff dedicated for the purpose of authenticating and authorizing each party requesting access to its proprietary information. This is a situation that the equipment manufacturer may not like to occur, since the equipment manufacturer is not in the market place to authenticate and to authorize third parties.

If the equipment manufacturer solves this problem by outsourcing authentication and authorization tasks to third party service providers, the equipment manufacturer will have a similar challenge of determining whether a commercial software developer was authenticated and authorized by the proper third party service provider, i.e., the identity of the authentication service provider becomes the new problem for the equipment manufacturer.

The problem of knowing the identity of a business partner is not unique to electronic equipment manufacturers. Similar situations may occur in other industries, such as in construction industry, a construction company dealing with many unknown subcontractors, who need to access construction information before being able to submit bids.

### SUMMARY OF THE INVENTION

The present invention provides a unique solution to the aforementioned problem. The systems and methods according to the present invention enables a business owner to outsource the unpleasant task of authenticating each unknown business partners and at same time authorizing those business partners who have been authenticated to access its resources. The business owner can rest assured those business partners have been authenticated by a known third party service provider.

The systems and methods according to the present invention involves a business owner, such as an equipment manufacturer, to enter into a contract with an independent party, also known as a certification authority, for authenticating and authorizing previously unknown business partners. Generally, the certification authority is a party having access to a plurality of information sources and capable of issuing digital certificates for online identification purposes. Preferably, the certification authority should have access to financial information, such a credit-related database, and this financial information may be encrypted into the digital certificates to provide additional information to a business owner. The certification authority takes corporate information from previously unknown, but potential business partners and verifies this information against independent sources. If the information provided by these potential business partners is confirmed against independent sources, then the certification authority authenticates and authorizes the business partners by issuing digital certificates to these business partners. The certification authority also informs the equipment manufacturer, a business owner, about the authentication of the business partners and sends copies of the digital certificates to the equipment manufacturer.

The newly authenticated business partners can then approach the equipment manufacturer's limited access web site to access sensitive information. An authenticated business partner would identify himself by providing some identification information and the digital certificate issued by the certification authority. The equipment manufacturer will then verify the identity of this authenticated business partner by comparing the digital certificate provided with the copy of the digital certificate sent by the certification authority. If the digital certificates match, then the business partner is authenticated and granted access to the web site. If the digital certificates do not match, then the access is declined.

The equipment manufacturer may also obtain additional corporate information and financial information about the authenticated business partner through the digital certificate.

The certification authority can also revoke a digital certificate on behalf of the equipment manufacturer. For some reason if the equipment manufacturer decides to no longer work with a business partner and no longer allows the access of its web site by this business partner, the equipment manufacturer can inform the certification authority about its decision. The certification authority party will then remove the digital certificate issued to this business partner from the list of digital certificates provided to the equipment manufacturer. Subsequently, this business partner will no longer be able to access the equipment manufacturer's web site.

### BRIEF DESCRIPTION OF THE DRAWINGS

FIG. 1 is an architecture diagram illustrating a system according to one embodiment of the present invention.

FIG. 2 is a flow chart for a business owner's process according to an embodiment of the invention.

FIG. 3 is a flow chart for a certification authority according to one embodiment of the present invention.

### DETAILED DESCRIPTION OF THE INVENTION

In online transactions between two parties where the identity of one party is important to another party digital certificates are often used to “authenticate” the identity of each party. Digital certificates are specially issued digital messages based on Public Key encryption system. Digital certificate can be thought of as a brief message the trusted certification authority signs, and which contains, either explicitly or implicitly, a reference to a public-key that is being certified and the identity of the public-key's owner. For example, if “C” provides a certificate for “A” and “A” uses its private key to encrypt messages in its dealing with “B;” then recipient “B” can use “A's” public key to decrypt the messages, provided that “B” trust “C,” and provided that “B” possess “C's” certification of “A's” public key. The messages can only be decrypted with the public key of the issuer, “A,” and if “B” receives the public key through the digital certificate issued by “C,” a trusted certificate authority, then “B” can rest assure that the messages are from “A.” Digital certificates rely on encryption technologies to ensure its integrity. Encryption is commonly undertaken to ensure the authenticity of the information, that is, a message that purports to originate with a particular source actually did and has not been tampered with.

A widely used method for encrypting traffic on the Internet is the Secure Sockets Layer (SSL) created by Netscape Communications. SSL uses a type of encryption known as public key encryption system. In a public key encryption system, each network participant has two related keys. A public key which is publicly available and a related private key or secret key which is not. The public key is used to encrypt information and the private key is used to decrypt information. Simply speaking the public and private keys are separate, but mathematically linked algorithms for encrypting and decrypting. The public and private keys are duals of each other in the sense that material encrypted with the public key can only be decrypted using the private key. The keys utilized in public key encryption systems are such that information about the public key does not help to deduce the corresponding private key. The public key can be published and widely disseminated across a communications network and material can be sent in privacy to a recipient by encrypting the material with recipient's public key. Only the recipient can decrypt material encrypted with the recipient's public key. Not even the originator who does the encryption using the recipient's public key is able to decrypt the encrypted material.

Message authentication can also be achieved utilizing encryption systems. In a public key encryption system, if the sender encrypts information using the sender's private key, all recipients will be able to decipher the information using the sender's public key, which is available to all. The recipients can be assured that the information originated with the sender, because the public key will only decrypt material encrypted with the sender's private key. Since presumably, only the sender has the private key, the sender cannot later disavow that he sent the information. However, no data security system is impenetrable. Public Key encryption systems are most vulnerable if the public keys are tampered with. Although encryption protects the confidentiality of a document, it does not verify that the person holding the key is the authorized key holder.

One way to prevent this from happening is through the use of digital certificates issued by a trusted third party. Digital certificates, that is, specially issued files containing identification and other information, provide a level of security and authentication that gives vendors, suppliers and others comfort as they increasingly commit to electronic commerce. Digital certificates provide electronic confirmation of the identity of a potential customer or another user seeking to access a server.

The systems and methods according to the present invention allows a commercial entity to outsource some repetitive and unpleasant tasks of authenticating unknown business partners, which are not part of its core business, to a third party. The present invention is useful to those commercial entities that deals with many unknown potential business partners over the Internet, where learning the identity of parties poses a practical difficulty.

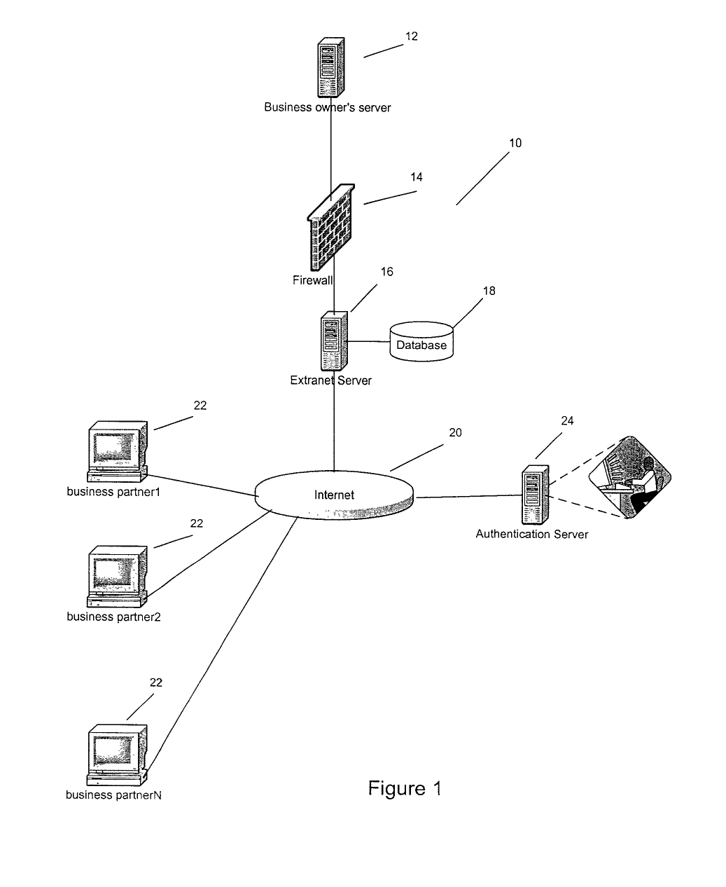

FIG. 1 illustrates architecture of a system 10, wherein a business owner's extranet server 14 is made available through a communication network 20 to a plurality of business partners 22.

The extranet server 14 can be a general-purpose computer equipped with a database 18 and is generally part of a limited access network. The database 18 may contain commercial information that the business owner wants to make available to its business partners 22. It may also contain the identification information of the business partners 22.

The extranet server 14 is connected directly to the communication network 20, which may be any kind of network that provides communication between computers including the Internet. The extranet server 14 may also be connected to the business owner's server through a firewall 14. The firewall 14 is a combination of hardware and software that limits the exposure of a computer or group of computers to an attack from outside. Without a firewall 14, anyone on the Internet could theoretically access computers on a corporation's network. The firewall enforces a boundary between two or more networks. In the system shown in FIG. 1, the firewall 14 enforces separation between the business owner's server 12 and the extranet server 16. The firewall 14 would allow the business owner's server 12 to update the database 18, but will prevent unauthorized users on the Internet to access the business owner's server 12. The firewall 14 may be incorporate in either the business owner's server 12 or the extranet server 16.

In an alternate embodiment, the extranet server 16 may have no direct connection to the business owner's server 12. In this case, the database update may be accomplished by the business owner's server 12 recording updated information on a tape and loading the tape onto the extranet server 16.

A business partner 22, who wants to access to the information on the extranet server 16, may have to access an authentication server 24 that belongs to a certification authority first, if it has not been certified by the certification authority. A non-certified business partner 22 visits a web site hosted by the authentication server 24, where a series of screens prompt for corporate information. The information collected is forwarded to the certification authority for verification.

The certification authority is a trusted third-party organization or company that issues digital certificates used to create digital signatures and public-private key pairs. These pairs allow all system users to verify the legitimacy of all other system users with assigned certificates. The role of the certification authority is to guarantee that the individual granted the unique certificate is, in fact, who he or she claims to be. Usually this means that the certification authority has an arrangement with a financial institution, such as a credit card company, which provides it with information to confirm an individuals claimed identity. A certification authority is a critical component in data security and electronic commerce because they guarantee that the two parties exchanging information are really who they claim to be. The certification authority uses other third party sources to verify the corporate information collected from a non-certified business partner 22.

The certification authority verifies the corporate information collected, which may include Articles of Incorporation, Partnership Agreement, business licenses issued by government authorities, etc. The certification authority may check with the authority of the state of incorporation to verify the incorporation. The certification authority may also check with state agencies to verify business licenses. Commercial database, such as Dun & Bradstreet, may also be used to verify the corporate information.

The certification authority may also require a letter of authorization from the business partner 22. The letter of authorization specifies who in the business partner's organization is authorized to request and use the digital certificate on a corporation's behalf. The certification authority may verify with the proper corporate official the veracity of the letter of authorization provided.

The verification process may be automatic or manual. When the information from the third party sources is online, then the verification will be automated, i.e., done electronically. A manual verification process may be employed whenever automated process is not feasible.

The verification may be processed in real time or in batch mode. If it is processed in real time and the certification authority certifies the corporate information collected from the business partner, then a digital certificate is issued immediately to the business partner. If the verification is in batch mode, the business partner may receive a notification about the verification result. The business partner may receive instruction on how to proceed to obtain his digital certificate, if it is certified. The business partner may need to re-visit the certification authority's web site to retrieve the digital certificate; the business partner may also receive the digital certificate through a secure e-mail.

After the certification authority verifies the corporate information, the certification authority issues a digital certificate to the non-certified business partner and this becomes a certified business partner. The certification authority will update its database to reflect the new status and sends a database update to the business owner. The business owner's server 12 needs to update its database, so it will recognize the business partner as a certified business partner. The business owner's server 12 will then update the extranet server 16 and its database 18.

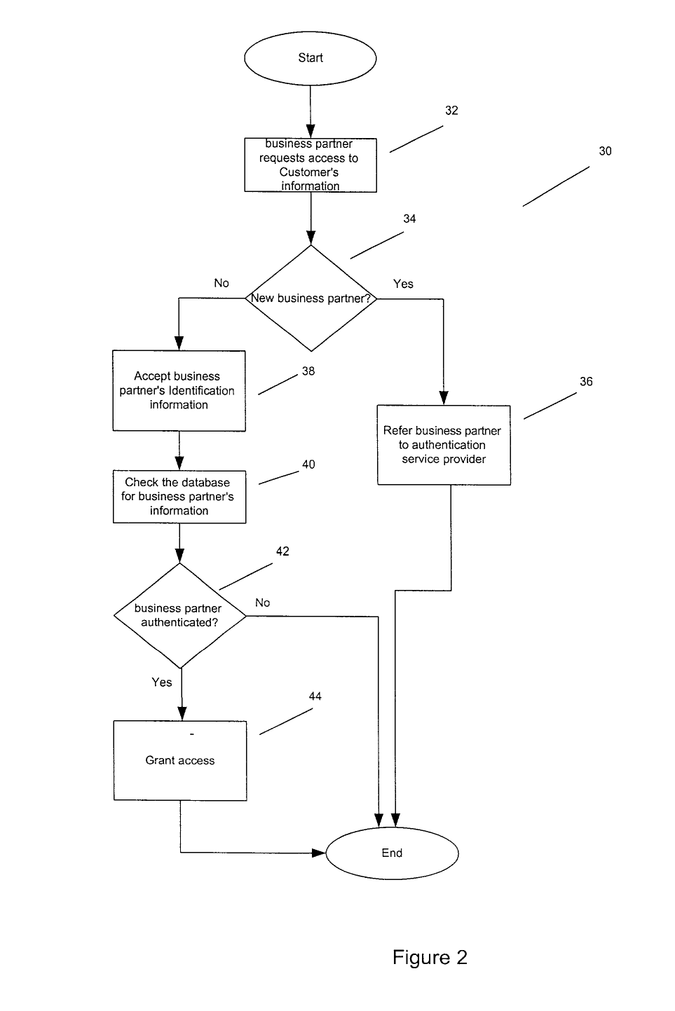

FIG. 2 illustrates a business owner process 30. A business owner, who has many potential business partners, may provide a general access point, a web site, on its extranet server 16 and direct all business partners to that web site. A business partner wanting to access the business owner's information, block 32, is asked whether it is a new business partner, block 34. If it is a new business partner who has not been certified, then the business owner directs it to the certification authority's web site, block 36.

If the business partner has been certified, then the business owner takes the identification information from the business partner, block 38. The identification may include a user identification code, a password, and a digital certificate.

The business owner checks its database 18 to check the information provided by the business partner, block 40. The verification, block 42, may include checking the database for an entry for the business partner and comparing the digital certificate received from the business partner with the digital certificate stored in the database, which is received from the certification authority. If the stored digital certificate compares with the digital certificate received from the business partner, it means that the business partner is whom he claims he is and it has been certified by the certification authority. If the business is not authenticated, the process is terminated. If the business partner is authenticated, then he is granted access to the business owner's information, block 44.

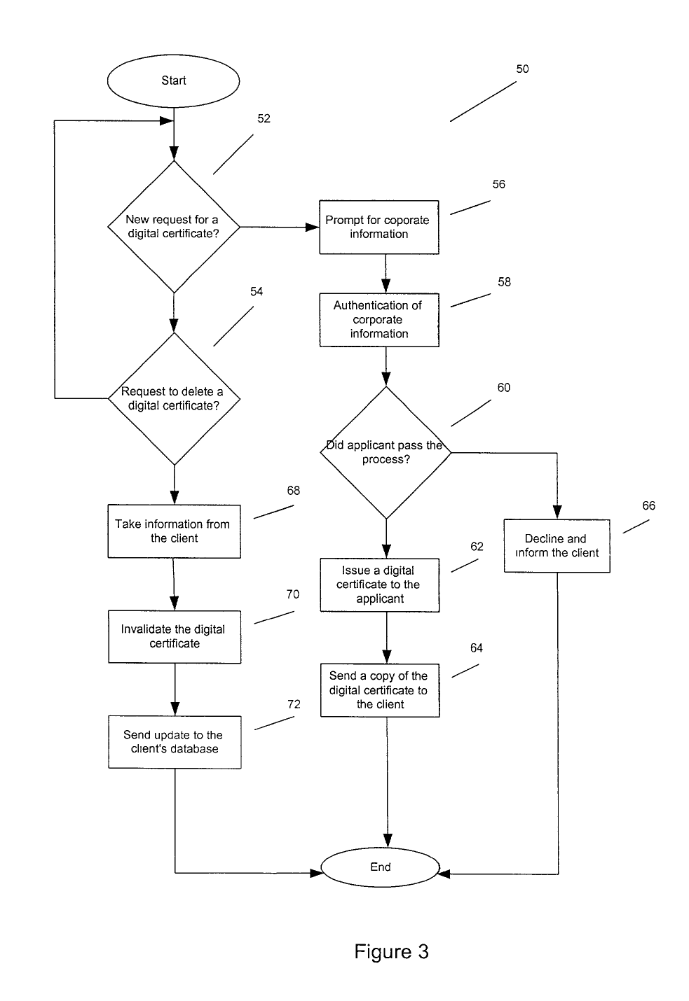

FIG. 3 is a certification authority process 50. When the certification authority receives a new request, the certification authority checks if it is a request for a new digital certificate, block 52. If it is a request from a potential business partner of a customer (a business owner), the certification authority asks for corporate information, block 56. The corporate information includes Articles of Incorporation, Partnership agreement, tax identification number, business license, letter of authorization, etc. This corporate information is authenticated, block 58, against third party sources, such as commercial databases, trade publications, government records, registries of Secretary of States, credit bureaus databases, etc. If an individual is requesting a digital certificate on behalf of a corporation through a letter of authorization, the certification authority may also inquire about the corporation's authenticity of the letter of the authorization.

If the certification authority does not certify the corporate information, it will decline to issue a digital certificate and informs the business owner about the decline, block 66. The certification authority may provide reasons for the decline to the business partner.

If the certification authority certifies the corporate information, it will issue a digital certificate to the business partner, block 62, and send a copy of the digital certificate to the business owner, block 64.

The digital certificate to be issued may include levels of permission. The levels of permission may depend on different factors, such as size of the corporation, business volume, credit worthiness, etc. The certification authority may consult with the credit bureau database in deciding what level of permission to grant for each business partner.

In an alternate embodiment, the certification authority may also revoke a digital certificate issued to a business partner. Generally, the revocation is initiated with request received from a business owner. The business owner may for some or any reason wish to no longer work with a specific business partner, and it needs to inform the certification authority about its decision to discontinue to work with this business partner.

The business owner sends a request to delete the digital certificate issued to that business partner to the certification authority. The certification authority checks the request, block 54, and takes information from this request, block 68. The certification authority invalidates the digital certificate by publishing it as an invalid digital certificate and removing it from its database, block 70. The certification authority also sends an update to the business owner, block 72, so the business owner may remove the digital certificate from its database.

In operation, the systems and methods according to the present invention allow a business owner, who has many potential business partners, to outsource its operation to authenticate potential business partners before permitting them to access some commercial information. For example, a general contractor may make project information available to potential subcontractors to use to prepare sub-contracting bids. The general contractor signs a contract with a certification authority granting the power to the certification authority to act on its behalf. The general contractor can specify the information that it requires from each potential subcontractor.

A subcontractor will not be able to access the information, unless a certification authority authenticates it. The subcontractor is directed to visit a certification authority's web site first, where it will be ask to provide corporate information.

The certification authority receives the information and verifies the information against Dun & Bradstreet or similar databases. The certification authority may also access the registry information from the Secretary of State to verify corporation information. The verification may also use a credit bureau database, if the information provided involves financial information. If the general contractor has specific requirements on the information to be verified, the subcontractor will be prompted to provide this specific information and the authentication authority will verify this information.

After verifying the information, the certification authority issues a digital certificate with the subcontractor's corporate information. The certification authority also sends a copy of the digital certificate to the general contractor, so the general contractor will recognize the digital certificate.

The subcontractor can then access the general contractor's web site by providing the digital certificate. The general contractor compares the digital certificate with the digital certificate received from the certification authority, if they match, the access is granted to the subcontractor.

It is to be understood that the embodiments and variations shown and described herein are merely illustrative of the principles of this invention and that various modifications may be implemented by those skilled in the art without departing from the scope and spirit of the invention. In disclosing the invention in this document, terms such as “firewall,” “server,” “Internet,” “network,” “intranet,” “extranet,” “digital certificate,” “storage device,” and “database” include such functionalities, plus any other functionalities, whether existing at the time of this document or in the future, which are not substantially different, or which function substantially the same way to achieve substantially the same result. Such functionalities can be implemented in one location or multiple locations; in hardware or software; actually or virtually, distributed or nondistributed, networked or non-networked, circuit-switched or packet-switched, electronically or nonelectronically, optically or nonoptically, biologically or nonbiologically.

We claim:

1. A method for securing electronic transactions between a business owner and a plurality of business partners in a limited access electronic network comprising:
determining if a visiting business partner is a certified business partner;
directing the visiting business partner to a certification authority, if the visiting business partner is not a certified business partner, the certification authority being an entity capable of issuing digital certificates;
receiving identification information from the visiting business partner, if the visiting business partner is a certified business partner, the identification information includes a digital certificate issued by the certification authority;
verifying the identification information of the visiting business partner against a database; and
granting access to the limited access electronic network, if the identification information of the visiting business partner is verified.

2. The method of claim 1 further comprising
signing a service contract between the business owner and the certification authority, wherein the business owner authorizes the certification authority to certify information provided by non-certified business partners.

3. The method of claim 1 further comprises
receiving database updates from the certification authority, and
updating the database with the database updates.

4. The method of claim further comprises
sending a list of business partners to the certification authority, wherein the digital certificates for the business partners in the list are to be deleted.

5. The method of claim 1, wherein the certification authority is a credit bureau.

6. The method of claim 1, wherein the digital certificate includes credit related information.

7. The method of claim 1, wherein the digital certificate includes a level of permission granted.

8. A method for providing secure transactions between a business owner and a plurality of business partners in a limited access electronic network, wherein the access to the limited access electronic network is granted to business partners who have been certified, said method comprising:
providing a certification authority, wherein the certification authority is capable of issuing digital certificates;
receiving identification information from a business partner;
creating an entry in a database for the business partner, if the business partner has not been certified;
receiving corporate information from the business partner, if the business partner has not been certified;
verifying the corporate information received from the business partner, wherein the verification includes consulting credit database maintained by the certification authority;
issuing a digital certificate to the business partner, if the corporate information is verified; and
sending a database update to the business owner, wherein the database update includes information on the digital certificate issued to the business partner.

9. The method of claim 8 further comprises:
receiving a list of business partners from the business owner, wherein the business partners on the list are to be denied digital certificates; and
invalidating the digital certificate of the business partners on the list.

10. The method of claim 8, wherein the digital certificate includes at least some of the corporate information.

11. The method of claim 8, wherein the identification information includes article of incorporation.

12. The method of claim 8, wherein the identification information includes a letter of authorization.

13. The method of claim 8, wherein the step of verifying the corporate information further includes consulting commercial database.

14. The method of claim 8, wherein the step of verifying the corporate information further includes consulting government records.

15. The method of claim 8, wherein the digital certificate has a level of permission attached to it.

16. The method of claim 8, wherein the certification authority is a credit bureau.

17. The method of claim 8, wherein the digital certificate includes credit related information.

18. A system for providing secure transactions on a limited access network between a business owner and a plurality of business partners, the system comprising:
a plurality of business partners having access to the limited access network, wherein the limited access network is connected to a communication network;
an extranet server accessible through the communication network, wherein the extranet server is part of the limited access network; and
a certification authority accessible through the communication network, wherein the certification authority is capable of issuing digital certificates.

19. The system of claim 18, wherein the certification authority is a credit bureau.

20. The system of claim 18, wherein the certification authority consults a credit bureau database before issuing a digital certificate.
